(19) United States
(12) Patent Application Publication
(10) Pub. No.: US 2025/0196660 A1
(43) Pub. Date: Jun. 19, 2025

(54) METHOD AND VEHICLE FOR DRIVING CONTROL USING ADAPTIVE REGENERATIVE BRAKING

(71) Applicants: Hyundai Motor Company, Seoul (KR); Kia Corporation, Seoul (KR)

(72) Inventors: Chang Eun Na, Hwaseong-si (KR); Jin Yong Kim, Hwaseong-si (KR); Hong Gi Park, Hwaseong-si (KR); Hyun Seok Jang, Hwaseong-si (KR)

(21) Appl. No.: 18/893,485

(22) Filed: Sep. 23, 2024

(30) Foreign Application Priority Data
Dec. 13, 2023 (KR) 10-2023-0180886

(51) Int. Cl. B60L 15/20; B60L 7/18; B60L 58/12

(52) U.S. Cl. CPC B60L 15/2027; B60L 7/18; B60L 58/12; B60L 2240/12

(57) ABSTRACT

An embodiment driving control method of a vehicle using adaptive regenerative braking includes receiving a request of a function for adaptive downhill driving for implementing maintenance of a constant speed during downhill driving of the vehicle by the adaptive regenerative braking and a set speed accompanying the request, in response to a vehicle speed during the downhill driving being equal to or higher than an upper limit above the set speed, controlling driving of the vehicle by tuning regenerative braking according to a constant speed mode belonging to a type of the adaptive generative braking to make the vehicle speed converge to the set speed, and in response to the vehicle speed during the downhill driving being equal to or lower than a lower limit below the set speed, controlling the driving of the vehicle by reducing the regenerative braking through release of the constant speed mode.

### CROSS-REFERENCE TO RELATED APPLICATIONS

This application claims the benefit of Korean Patent Application No. 10-2023-0180886, filed on Dec. 13, 2023, which application is hereby incorporated herein for all purposes by this reference.

### TECHNICAL FIELD

The present disclosure relates to a method and vehicle for driving control using adaptive regenerative braking.

### BACKGROUND

Following the recent trend of requiring eco-friendly energy resources, vehicles are being designed to operate by electric energy instead of fossil fuels. According to types, electric vehicles may be equipped with electric batteries alone or may be operated as fuel cell electric vehicles (FCEVs) using electric batteries as well as fuel cells as their main energy source. A fuel cell-based vehicle generates power for charging an electric battery and thus satisfies performance related to usage, weight, and travel distance.

Meanwhile, for braking of an electric vehicle, when an acceleration request ceases to exist or there is a main braking request through a foot brake pedal, regeneration (or regenerative braking) may be involved in braking of the electric vehicle. An existing regeneration function performs control that generates a specific deceleration, irrespective of a slope state according to uphill and downhill routes. However, regeneration applied to a downhill slope over a long distance causes an excessive braking force due to the continuous occurrence of a counter electromotive force so that ride comfort and convenience may be degraded. To prevent an excessive braking force, a large vehicle like an electric commercial car may be equipped with a brake assist device, for example, a drive line retarder, for suppressing rotation of a shaft, which couples wheels and a motor, or a shaft in transmission. The brake assist device may control driving for better ride comfort than regeneration, but a battery is charged very low due to regeneration, which may significantly degrade charging efficiency. Accordingly, because the existing regeneration and the existing brake assist device do not include adaptive braking control according to a slope state, they do not provide any braking control that ensures ride comfort, convenience, and high charging efficiency all together.

### SUMMARY

The present disclosure relates to a method and vehicle for driving control using adaptive regenerative braking. Particular embodiments relate to a driving control method and vehicle that not only improve ride comfort, use convenience, and safety during downhill driving but also secure optimal charging efficiency by active regenerative braking control.

Embodiments of the present disclosure are technically directed to providing a driving control method and vehicle using adaptive regenerative braking, which not only improve ride comfort, use convenience, and safety during downhill driving but also secure optimal charging efficiency by active regenerative braking control.

The technical problems solvable by embodiments of the present disclosure are not limited to the above technical problems and other technical problems which are not described herein will be clearly understood by a person having ordinary skill in the technical field to which the present disclosure belongs from the following description.

According to embodiments of the present disclosure, there is provided a driving control method of a vehicle using adaptive regenerative braking. The method comprises, before or after entry of the vehicle into a downhill road, receiving a request of a function for adaptive downhill driving for implementing maintenance of a constant speed during downhill driving of the vehicle by the adaptive regenerative braking and a set speed accompanying the request of the function, in response to a vehicle speed during the downhill driving being equal to or higher than an upper limit above the set speed, controlling driving of the vehicle by tuning regenerative braking according to a constant speed mode belonging to a type of the adaptive generative braking to make the vehicle speed converge to the set speed, and in response to the vehicle speed during the downhill driving being equal to or lower than a lower limit below the set speed, controlling the driving of the vehicle by reducing the regenerative braking through release of the constant speed mode.

According to an embodiment of the present disclosure, the request of the function is received by at least one of a user's request, which turns on an adaptive downhill driving function, and the user's acceleration demand level that is below a reference demand level, and the set speed is determined as a vehicle speed at a time when the request of the function is received.

According to an embodiment of the present disclosure, the entry of the vehicle into the downhill road is determined by at least one of map information associated with a route on which the vehicle is running, slope information on the route, and speed information of the vehicle on the route, and the entry based on the speed information determines that the vehicle is running on the downhill road when an acceleration request of the user is not received and the vehicle speed is higher than the set speed.

According to an embodiment of the present disclosure, the controlling of the driving of the vehicle to make the vehicle speed converge to the set speed further comprises, in response to a charge state for a battery of the vehicle being equal to or greater than a threshold charge amount during the downhill driving, disabling the adaptive regenerative braking not to apply the constant speed mode and controlling the driving of the vehicle by one of a manipulation of the user and a brake assist request of the user, wherein the brake assist request is identified as a use request of the user for a retarder.

According to an embodiment of the present disclosure, the vehicle is equipped with a retarder that is available for brake assist during the downhill driving, and the method further includes disabling the brake assist by the retarder and enabling an operation of the adaptive regenerative braking during the downhill driving when the request of the user for the function and a use request of the user for the retarder are present.

According to an embodiment of the present disclosure, the controlling of the driving of the vehicle to make the vehicle converge to the set speed includes compensating required torque for driving control based on a change of slope of the downhill road on which the vehicle is running and controlling the driving by using the compensated required torque.

According to an embodiment of the present disclosure, after the receiving of the request of the function and the set speed and before the entry of the vehicle into the downhill road, in response to a difference between the vehicle speed and the set speed during the downhill driving being equal to or greater than a reference speed difference, the method further includes determining whether or not a redetermination condition of the set speed is satisfied and, in response to the redetermination condition being satisfied, resetting the vehicle speed to the set speed.

According to an embodiment of the present disclosure, the determining of whether or not the redetermination condition is satisfied determines whether or not the redetermination condition is satisfied based on downhill information associated with a downhill route for driving and torque information of the vehicle on the downhill route, wherein the downhill information includes an average slope of the downhill route and a downhill distance of the downhill route, and the torque information includes resistance torque caused by resistance according to the downhill route and required torque that is determined by the constant speed mode, and wherein the redetermination condition is determined to be satisfied when the average slope is equal to or greater than a threshold slope, the slope distance is equal to or greater than a threshold distance, and a sum of the resistance torque and the required torque is greater than a predetermined value.

According to an embodiment of the present disclosure, after the receiving of the request of the function and the set speed, the method includes enabling an operation of the adaptive regenerative braking during the downhill driving, before application of driving control according to the constant speed mode or during execution of the application, detecting whether or not a situation excluding application of the constant speed mode occurs, in response to the situation being detected, disabling the driving control according to the constant speed mode, and controlling the driving of the vehicle in another mode of the adaptive regenerative braking based on situation information of the detected situation.

According to an embodiment of the present disclosure, the controlling of the driving of the vehicle in the another mode comprises determining, based on the situation information, one mode of a plurality of modes associated with the type of the adaptive regenerative braking and controlling the driving of the vehicle by a regenerative braking method in the determined mode, wherein the plurality of modes includes a required deceleration mode and a following deceleration mode, the required deceleration mode is a type based on a speed of a dynamic object that is on a route ahead of the vehicle and has a decreasing relative distance from the vehicle or based on a speed required by a static object located on the route ahead of the vehicle, and the following deceleration mode is a type based on a speed that is estimated from traffic information on the route ahead of the vehicle.

According to embodiments of the present disclosure, there is provided a vehicle implementing driving control using adaptive regenerative braking. The vehicle includes a memory configured to store at least one instruction for controlling the vehicle and a processor configured to execute the at least one instruction stored in the memory, wherein the processor is further configured to, before or after entry of the vehicle into a downhill road, receive a request of a function for adaptive downhill driving for implementing maintenance of a constant speed during downhill driving of the vehicle by the adaptive regenerative braking and a set speed accompanying the request of the function, in response to a vehicle speed during the downhill driving being equal to or higher than an upper limit above the set speed, control driving of the vehicle by tuning regenerative braking according to a constant speed mode belonging to a type of the adaptive generative braking to make the vehicle speed converge to the set speed, and in response to the vehicle speed during the downhill driving being equal to or lower than a lower limit below the set speed, control the driving of the vehicle by reducing the regenerative braking through release of the constant speed mode.

According to an embodiment of the present disclosure, the request of the function is received by at least one of a user's request, which turns on an adaptive downhill driving function, and the user's acceleration demand level that is below a reference demand level, wherein the set speed is determined as a vehicle speed at a time when the request of the function is received.

According to an embodiment of the present disclosure, the entry of the vehicle into the downhill road is determined by at least one of map information associated with a route on which the vehicle is running, slope information on the route, and speed information of the vehicle on the route, and the entry based on the speed information determines that the vehicle is running on the downhill road when an acceleration request of the user is not received and the vehicle speed is higher than the set speed.

According to an embodiment of the present disclosure, the processor is further configured to, when controlling the driving of the vehicle to make the vehicle speed converge to the set speed, in response to a charge state for a battery of the vehicle being equal to or greater than a threshold charge amount during the downhill driving, disable the adaptive regenerative braking not to apply the constant speed mode and control the driving of the vehicle by one of a manipulation of the user and a brake assist request of the user, wherein the brake assist request is identified as a use request of the user for a retarder.

According to an embodiment of the present disclosure, the vehicle is equipped with a retarder that is available for brake assist during the downhill driving, and the processor is further configured to disable the brake assist by the retarder and enable an operation of the adaptive regenerative braking during the downhill driving when the request of the user for the function and a use request of the user for the retarder are present.

According to an embodiment of the present disclosure, the controlling of the driving of the vehicle to make the vehicle converge to the set speed includes compensating required torque for driving control based on a change of slope of the downhill road on which the vehicle is running and controlling the driving by using the compensated required torque.

According to an embodiment of the present disclosure, the processor is further configured to, after receiving the request of the function and the set speed, before the entry of the vehicle into the downhill road, in response to a difference between the vehicle speed and the set speed during the downhill driving being equal to or greater than a reference speed difference, determine whether or not a redetermination condition of the set speed is satisfied, and in response to the redetermination condition being satisfied, reset the vehicle speed to the set speed.

According to an embodiment of the present disclosure, the determining of whether or not the redetermination condition is satisfied determines whether or not the redetermination condition is satisfied based on downhill information associated with a downhill route for driving and torque information of the vehicle on the downhill route, wherein the downhill information includes an average slope of the downhill route and a downhill distance of the downhill route, and the torque information includes resistance torque caused by resistance according to the downhill route and required torque that is determined by the constant speed mode, and wherein the redetermination condition is determined to be satisfied when the average slope is equal to or greater than a threshold slope, the slope distance is equal to or greater than a threshold distance, and a sum of the resistance torque and the required torque is greater than a predetermined value.

According to an embodiment of the present disclosure, the processor is further configured to, after receiving the request of the function and the set speed, enable an operation of the adaptive regenerative braking during the downhill driving, before application of driving control according to the constant speed mode or during execution of the application, detect whether or not a situation excluding application of the constant speed mode occurs, in response to the situation being detected, disable the driving control according to the constant speed mode, and control the driving of the vehicle in another mode of the adaptive regenerative braking based on situation information of the detected situation.

According to an embodiment of the present disclosure, the controlling of the driving of the vehicle in the another mode comprises determining, based on the situation information, one mode of a plurality of modes associated with the type of the adaptive regenerative braking and controlling the driving of the vehicle by a regenerative braking method in the determined mode, wherein the plurality of modes includes a required deceleration mode and a following deceleration mode, the required deceleration mode is a type based on a speed of a dynamic object that is on a route ahead of the vehicle and has a decreasing relative distance from the vehicle or based on a speed required by a static object located on the route ahead of the vehicle, and the following deceleration mode is a type based on a speed that is estimated from traffic information on the route ahead of the vehicle.

The features briefly summarized above for this disclosure are only exemplary aspects of the detailed description of the disclosure which follow and are not intended to limit the scope of the disclosure.

The technical problems solvable by embodiments of the present disclosure are not limited to the above technical problems and other technical problems which are not described herein will be clearly understood by a person (hereinafter referred to as an ordinary technician) having ordinary skill in the technical field to which the present disclosure belongs from the following description.

According to embodiments of the present disclosure, it is possible to provide a driving control method and vehicle using adaptive regenerative braking which not only improve ride comfort, use convenience, and safety during downhill driving but also secure optimal charging efficiency by active regenerative braking control.

The effects obtainable from embodiments of the present disclosure are not limited to the above-mentioned effects, and other effects not mentioned herein will be clearly understood by those skilled in the art through the following descriptions.

### BRIEF DESCRIPTION OF THE DRAWINGS

FIG. 1 is a view exemplifying a vehicle communicating with another device to transmit and receive data.

FIG. 2 is a view showing constituent modules of a vehicle according to an embodiment of the present disclosure.

FIG. 3 is a flowchart of a driving control method using adaptive regenerative braking according to another embodiment of the present disclosure.

FIG. 4 is a view showing a control loop to which a constant speed mode of adaptive regenerative braking is applied.

FIG. 5 is a view showing a control loop for determining required torque according to downhill slope compensation.

FIG. 6 is a timing chart exemplifying determination of required torque according to downhill slope compensation and constant speed maintenance converging into a set speed.

FIG. 7 is a view exemplifying a vehicle speed change on a downhill route according to initiation and release of a constant speed mode.

FIG. 8 is a flowchart for a process of redetermining a set speed according to yet another embodiment of the present disclosure.

FIG. 9 is a view schematically exemplifying a process of redetermining a set speed.

FIG. 10 is a flowchart for a process of determining a mode of adaptive regenerative braking based on an exceptional situation according to yet another embodiment of the present disclosure.

FIG. 11, which includes FIGS. 11A-11C, is a view schematically exemplifying exceptional situations.

### DETAILED DESCRIPTION OF ILLUSTRATIVE EMBODIMENTS

Hereinafter, exemplary embodiments of the present disclosure will be described in detail with reference to the accompanying drawings so that those skilled in the art may easily implement the present disclosure. However, the present disclosure may be implemented in various different ways and is not limited to the embodiments described herein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to,” “coupled to,” or “linked to” another element, this may mean that an element is “directly connected to,” “directly coupled to,” or “directly linked to” another element or is “connected to,” “coupled to,” or “linked to” another element with yet another element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an embodiment could be termed a second element in another embodiment, and, similarly, a second element in an embodiment could be termed a first element in another embodiment, without departing from the scope of the present disclosure.

In the present disclosure, elements that are distinguished from each other are for clearly describing each feature, and they do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

The advantages and features of the present invention and the way of attaining them will become apparent with reference to embodiments described below in detail in conjunction with the accompanying drawings. Embodiments, however, may be embodied in many different forms and should not be constructed as being limited to example embodiments set forth herein. Rather, these embodiments are provided so that this disclosure will be complete and will fully convey the scope of the invention to those skilled in the art.

In the present disclosure, each of phrases such as “A or B,” “at least one of A and B,” “at least one of A or B,” “A, B or C,” “at least one of A, B and C,” and “at least one of A, B, C or a combination thereof” may include any one or all possible combinations of the items listed together in the corresponding one of the phrases.

In the present disclosure, expressions of location relations used in the present specification such as “upper,” “lower,” “left,” and “right” are employed for the convenience of explanation, and in case drawings illustrated in the present specification are inversed, the location relations described in the specification may be inversely understood. Hereinafter, embodiments of the present disclosure will be described with reference to the accompanying drawings.

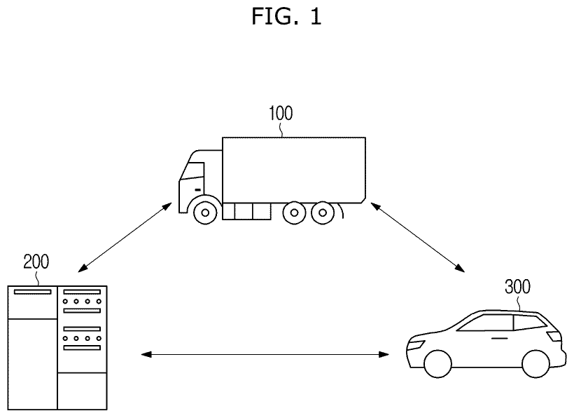

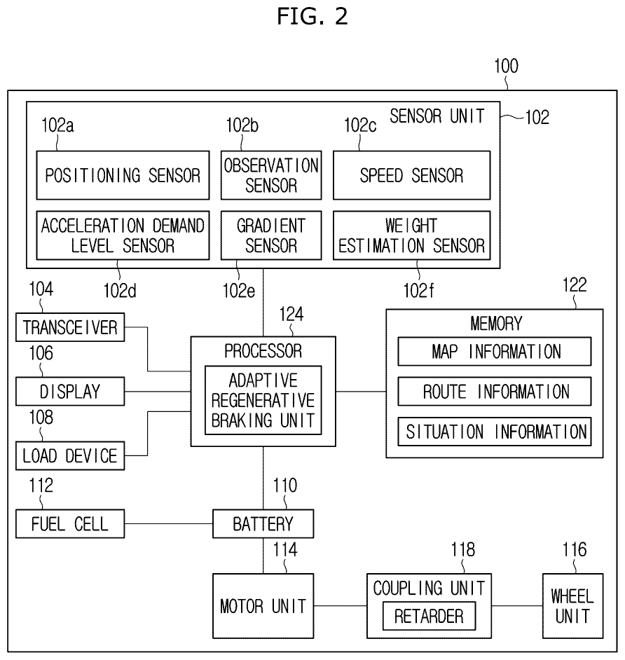

Hereinafter, with reference to FIG. 1 and FIG. 2, a vehicle implementing driving control using adaptive regenerative braking according to an embodiment of the present disclosure will be described. FIG. 1 is a view exemplifying a vehicle communicating with another device to transmit and receive data.

Referring to FIG. 1, a vehicle 100 may be driven based on electric energy. In the case of electric energy, for example, the vehicle 100 may be a pure battery-based vehicle driven only by a high-voltage battery or employ a gas-based fuel cell as an energy source. In the case of a fuel cell, the vehicle 100 may charge a high-voltage battery by power generation of the fuel cell and execute various functions required by the modules of the vehicle 100 by output power of the high-voltage battery. In addition, a fuel cell may use various types of gas capable of generating electric energy, and for example, the gas may be hydrogen. However, without being limited thereto, various gases may be applicable.

For convenience of explanation, embodiments of the present disclosure describe an example in which an electric energy vehicle is the fuel cell-based vehicle 100. However, the present disclosure is applicable to a vehicle where a high-voltage battery and a cell are of different types and which employs a method of charging the high-voltage battery by power generation of the cell to output power for the start-up and drive of the vehicle 100 and a load device 108. In addition, the present disclosure may also be applied to a vehicle that is driven only by an electric battery.

The vehicle 100 may refer to a device capable of moving. The vehicle 100 is a vehicle such as a ground vehicle driven on the ground and may be a normal passenger vehicle or commercial vehicle, a mobile office, or a mobile hotel. The vehicle 100 may be a four-wheel vehicle, for example, a sedan, a sports utility vehicle (SUV), and a pickup truck and may also be a vehicle with five or more wheels, for example, a bus, a lorry, a container truck, and a heavy vehicle. The vehicle 100 may be implemented by manual driving or autonomous driving (either semi-autonomous or full-autonomous driving).

Meanwhile, the vehicle 100 may perform communication with another device 200 or another vehicle 300 under the control of a communication control unit mounted in the vehicle 100. For example, the another device 200 may include a server 200 for supporting various control, state management, and driving of the vehicle 100, an intelligent transportation system (ITS) device for receiving information from an ITS, and various types of user devices.

The vehicle 100 may communicate with another vehicle or another device based on cellular communication, wireless access in vehicular environment (WAVE) communication, dedicated short range communication (DSRC) or short range communication, or any other communication scheme.

For example, the vehicle 100 may use LTE as a cellular communication network, a communication network such as 5G, a WiFi communication network, a WAVE communication network, and the like to communicate with the server 200 and the another vehicle 300. As another example, DSRC used in the vehicle 100 may be used for vehicle-to-vehicle communication. A communication scheme among the vehicle 100, the server 200, the another vehicle 300, and a user device is not limited to the above-described embodiment.

In order to support autonomous driving and various services for the vehicle 100, the server 200 may transmit various types of information and software modules used for controlling the vehicle 100 to the vehicle 100 as a response to a request and data transmitted from the vehicle 100 and a user device.

FIG. 2 is a view showing constituent modules of a vehicle according to an embodiment of the present disclosure.

The vehicle 100 may include a sensor unit 102, a transceiver 104, a display 106, and a load device 108.

The sensor unit 102 may be equipped with various types of detectors for sensing various states, maneuvers, and situations occurring or measured in external and internal environments of the vehicle 100 and for identifying position information of the vehicle 100.

Specifically, the sensor unit 102 may be equipped with a positioning sensor 102a for obtaining location information of the vehicle 100, an observation sensor 102b for recognizing a surrounding environment of the vehicle 100, a speed sensor 102c for measuring a speed of the vehicle 100, an acceleration demand level sensor 102d, a gradient sensor 102e, and a weight estimation sensor 102f. For example, the observation sensor 102b may be equipped with an image sensor, a lidar sensor, and a radar sensor. The radar sensor may detect the presence of an object around the vehicle and perceive a relative distance from the object, a speed of the object, and a moving direction of the object. The acceleration demand level sensor 102d may detect a demand level included in a user's acceleration request, and for example, sense a user's pedal maneuver amount through an acceleration pedal or the user's demand level through an acceleration interface. The acceleration demand level sensor 102d capable of measuring a user's pedal maneuver amount may be an acceleration pedal sensor (APS).

For example, the speed sensor 102c may be a wheel speed sensor, but without being limited thereto, may be implemented in various forms of sensors measuring a driving speed. The gradient sensor 102e may be a sensor that measures a slope for a route where the vehicle 100 is running. For example, the gradient sensor 102e may measure a stance of the vehicle 100 and a tilting angle of the vehicle 100 through a gyro sensor, an inertia sensor, and the like and output a slope of a route (or road) based on a measured value.

For example, the weight estimation sensor 102f may measure or estimate a weight of a load on the vehicle 100. For example, the load may be an occupant or luggage. The weight estimation sensor 102f may directly sense a weight of a load. The weight estimation sensor 102f may also indirectly sense a weight of a load through a specific module of the vehicle 100, for example, a change of suspension or a driving parameter of the vehicle 100 between a loaded state and an unloaded state, such as a change in driving speed, torque on a wheel, drive energy, and the like.

The present disclosure mainly describes sensors of the sensor unit 102 described through embodiments referred to herein but may further include a sensor for detecting various situations not listed herein.

The transceiver 104 may support mutual communication with the server 200, the another vehicle 300, and the like. In embodiments of the present disclosure, the transceiver 104 may transmit data generated or stored during driving to the server 200 and receive data and a software module transmitted from the server 200. In embodiments of the present disclosure, the vehicle 100 may transmit and receive data used in a method to and from the outside through the transceiver 104. In embodiments of the present disclosure, the transceiver 104 may receive and forward map information and situation information to a memory 122 and a processor 124.

The display 106 may serve as a user interface. By the processor 124, the display 106 may display an operating state and a control state of the vehicle 100, route information according to navigation, traffic information around the vehicle 100, information on a remaining energy quantity, a content requested by a driver, and the like to be output. The display 106 may be configured as a touch screen capable of sensing a driver input and receive a request of a driver indicated to the processor 124.

The load device 108 may be an auxiliary equipment mounted on the vehicle 100, which consumes power supplied from a battery 110 by use of an occupant or a user. In embodiments of the present disclosure, the load device 108 may be a type of electric device for non-driving purpose excluding a driving power system like a motor unit 114 for wheel drive. For example, the load device 108 may be an air-conditioning system, a light system, a seat system, and various devices installed in the vehicle 100.

The vehicle 100 may include the battery 110, a fuel cell 112, the motor unit 114, a coupling unit 118, and a wheel unit 116. The vehicle 100 is a mobility with a plurality of wheels, and all the wheels may be driven by being connected, for example, with the motor unit 114. In embodiments of the present disclosure, for convenience of explanation, the motor unit 114, the coupling unit 118, and the wheel unit 116 are illustrated separately in FIG. 2. According to the number of wheels of the vehicle 100, the motor unit 114, the coupling unit 118, and the wheel unit 116 increase according to the number, but because the motor unit 114, the coupling unit 118, and the wheel unit 116, which drive each wheel, have a same function, these members may be understood to represent modules that drive each wheel. As another example, only some of the wheels may be coupled with the motor unit 114, and wheels not coupled with the motor unit 114 may be driven by a wheel driven from a motor.

The battery 110 and the fuel cell 112 may both supply power permanently, or the battery 110 and the fuel cell 112 may be used as a main power source and an auxiliary power source respectively.

The battery no may be a pure electric battery that is configured as a secondary cell charged with electric energy. As another example, the battery 110 may have a higher energy density than the fuel cell 112 and thus be configured as a secondary cell that is rechargeable with high capacity. In case adaptive regenerative braking is performed according to embodiments of the present disclosure, the battery 110 may be charged by a counter electromotive force of the motor unit 114.

The fuel cell 112 may have a lower voltage output than the battery 110 but may be configured to have a high energy density or a high charging capacity. As an example, the fuel cell 112 may be configured as a hydrogen-based fuel cell that generates electric energy through reaction between hydrogen gas filling a tank (not shown) from outside and oxygen flowing from a supplier (not shown).

The battery 110 may be charged by receiving a voltage that is output by a converter (not shown) that converts a voltage of the fuel cell 112. In addition, the converter may supply power to a motor of the motor unit 114 and the load device 108, which are operated in a high voltage range, at a voltage converted from the fuel cell 112.

The motor unit 114 may generate a driving force by receiving electric power from the battery 110. The motor unit 114 may transmit the driving force to the wheel unit 116, and a wheel may be driven to rotate. For example, the motor unit 114 may be equipped with a motor for transmitting a driving force to the wheel unit 116 and a motor control module for controlling motor torque, a motor turning direction, and braking. The motor unit 114 may be driven by receiving electric power that is applied from the battery 110 via an inverter (not shown). An inverter may convert a specific form of electric power of the battery 110, for example, alternating current to another form, for example, direct current and reduce a voltage. The motor unit 114 may output a counter electromotive force when adaptive regenerative braking according to embodiments of the present disclosure is performed. The wheel unit 116 may include a main braking module for decelerating the drive of a wheel and a steering module for realizing horizontal control of a wheel.

The coupling unit 118 may be equipped with a mechanical component that transmits a driving force that is output from the motor unit 114. For example, the mechanical component may be a combination of a shaft and gears. As another example, the coupling unit 118 may shift a driving force and transmit the shifted driving force to the wheel unit 116, together with a module for transmitting a driving force. In the case of a large vehicle, the coupling unit 118 may be equipped with a brake assist module, for example, a retarder. For example, the retarder may be equipped with a hydraulic or electromagnetic device for suppressing a rotation of a shaft that couples the wheel unit 116 and the motor unit 114. Following a user's brake assist request, the retarder may decelerate the vehicle 100 during downhill driving, irrespective of regeneration and main braking. In embodiments of the present disclosure, in case a request for brake assist by the retarder and a request for adaptive regenerative braking are all present in downhill driving, the brake assist may be disabled and an operation of the adaptive regenerative braking may be enabled according to the processor 124 or a user's setting. The brake assist equipment and transmission described above may be omitted according to a specification of the vehicle 100.

In addition, the vehicle 100 may include the memory 122 and the processor 124.

The memory 122 may store an application for controlling the vehicle 100 and various data and load the application or read and record data at a request of the processor 124. In embodiments of the present disclosure, the memory 122 may have an application for receiving a request of a function for adaptive downhill driving and a set speed accompanying the request of the function and for controlling driving of the vehicle 100 by actively executing regeneration so that a vehicle speed may be maintained at the set speed during downhill driving according to a constant speed mode belonging to a type of adaptive downhill driving. The meanings of the adaptive regenerative braking and adaptive downhill driving using the same will be described below.

To this end, the memory 122 may hold and manage map information for identifying a location of the vehicle 100. Map information may be used to generate a driving route set in the vehicle 100 at a request of a user or the processor 124 or to obtain driving situation information on a route ahead. In addition, map information may be used for autonomous driving and include a low definition map or include a high definition map together with the low definition map. Map information may be provided to have various information and data included in the above-described object and environment.

For example, map information may have information on a road where the vehicle 100 is running, driving caution information associated with a static object provided on a road to encourage or surveil a specific type of driving, and the like. For example, the road information may include various data associated with road types and may have lanes, hills, crossings, downhill information, and uphill information. Uphill information and downhill information may include information on an average slope of an entire hill, information on detailed slopes according to each section of a hill, and distance information of an entire hill.

For example, the driving caution information may include a facility zone, where a supplementary facility for requesting or monitoring speed limitation is located, and a marking zone where a marking object associated with speed limitation is located. For example, a supplementary facility for deriving or monitoring speed limitation may include a speed camera, a speed limit, a sign related to a slow-down zone, and a speed bump. For example, a marking object may be a speed limit mark or a slow-down zone mark on a road. A protection zone may be a zone for protecting a predetermined object, for example, a weak pedestrian and a safety structure present near a road. For example, a protection zone may be a school zone, a children/elderly protection zone, and the like.

Route information may be created in response to a user's route guidance request or a request of the processor 124 according to autonomous driving and may be managed in the memory 122 to support driving.

Situation information may manage various situation data that are used for adaptive regenerative braking. Situation information may be obtained from the sensor unit 102, map information, and another device. The another device 200 may be the server 200, the another vehicle 300, and the like. Situation information associated with embodiments of the present disclosure may include dynamic object information on a front route of the vehicle 100, static object information requiring a specific form of driving on a front route, downhill information, and traffic information on a front route. To support active driving, situation information may have internal and external states of the vehicle 100 and an event on a route, which are influential on driving. For example, dynamic object information may be obtained from a radar sensor of the observation sensor 102b and data received from the another device 200. Static object information and downhill information may be acquired from road information of map information.

Traffic information may be acquired from the server 200 and include a traffic flow status around the vehicle 100. For example, the traffic information may include a degree of traffic smoothness and accident information on a road or route ahead of the vehicle 100. A degree of traffic smoothness is an indicator associated with a vehicle flow state on a road caused by driving/stopped vehicles and people and may be distinguished into, for example, traffic smoothness, delay, and jam. Accident information may be information associated with factors affecting a traffic flow on a road, where driving is to be performed, such as an accident, a construction work, and a worsening weather condition. Accident information may include intensity of a factor, and accident information may have a degree of traffic smoothness estimated according to factor intensity.

The processor 124 may perform overall control of the vehicle 100. The processor 124 may be configured to execute an application and an instruction stored in the memory 122.

In relation to embodiments of the present disclosure, the processor 124 may be implemented to function as an adaptive regenerative braking unit according to embodiments of the present disclosure by using an application, an instruction, and data stored in the memory 122. The processor 124 may control driving of the vehicle 100 by using adaptive regenerative braking. Adaptive regenerative braking is capable of controlling driving by generating regeneration based on a driving situation irrespective of a slope state according to a hill, unlike regeneration that performs control to generate a specific deceleration. Specifically, adaptive regenerative braking may control regeneration by a mode selected from a plurality of types based on a driving situation. In a driving situation on a flat land and a hill, when an acceleration request degree is equal to or lower than a preset demand level, the processor 124 may control driving by a following deceleration mode that tunes regeneration based on a speed that is estimated from traffic information of a route ahead.

In a driving situation where a relative distance is decreasing from a dynamic object, for example, a vehicle ahead on a route, when an acceleration request degree is equal to or lower than a preset demand level, driving may be controlled based on a required deceleration determined by a speed of a vehicle ahead and a required deceleration mode that adjusts regeneration based on a vehicle-to-vehicle distance for ensuring safety. A required deceleration mode may also be applied to a situation where there is a static object located on a route ahead and requiring a specific driving behavior. Specifically, for example, a specific driving behavior may be a speed limit included in driving caution information of a static object. In a driving situation where a static object for monitoring or inducing compliance with a speed limit, for example, a speed camera equipment is located on a route ahead, when the vehicle 100 is running at a speed higher than the speed limit, a demanded deceleration mode may be enabled to tune regeneration based on a required deceleration according to a distance between the vehicle 100 and the static object and the speed limit.

Adaptive regenerative braking according to embodiments of the present disclosure may be associated with control of regeneration that is controlled for driving at a constant speed on a downhill road. Adaptive regenerative braking on a downhill road may be triggered by a request for a function of adaptive downhill driving. This function may check a vehicle speed and situation information and execute a constant speed mode for actually driving constantly at a set speed, in response to the vehicle speed and the situation information satisfying a related condition. Along with the above-described modes, a constant speed mode may belong to a type of adaptive regenerative braking.

In relation to the function, the processor 124 may perform processing that, before or after the vehicle 100 enters a downhill road, receives a function of adaptive downhill driving for implementing maintenance of a constant speed during downhill driving of the vehicle 100 by adaptive regenerative braking and a set speed accompanying the request of the function. In response to a vehicle speed being higher than an upper limit above a set speed when downhill driving, the processor 124 may perform processing to control driving of the vehicle 100 so that regeneration increases according to a constant speed mode belonging to a type of adaptive regenerative braking and thus the constant speed is maintained at the set speed. In response to a vehicle speed being higher than a lower limit below the set speed when downhill driving, the processor 124 may implement processing that controls driving of the vehicle 100 by tuning regeneration through release of a constant speed mode. Decreasing regeneration may mean not only reducing a regeneration amount to a lower level but also turning regeneration off according to conditions of a road and a surrounding environment.

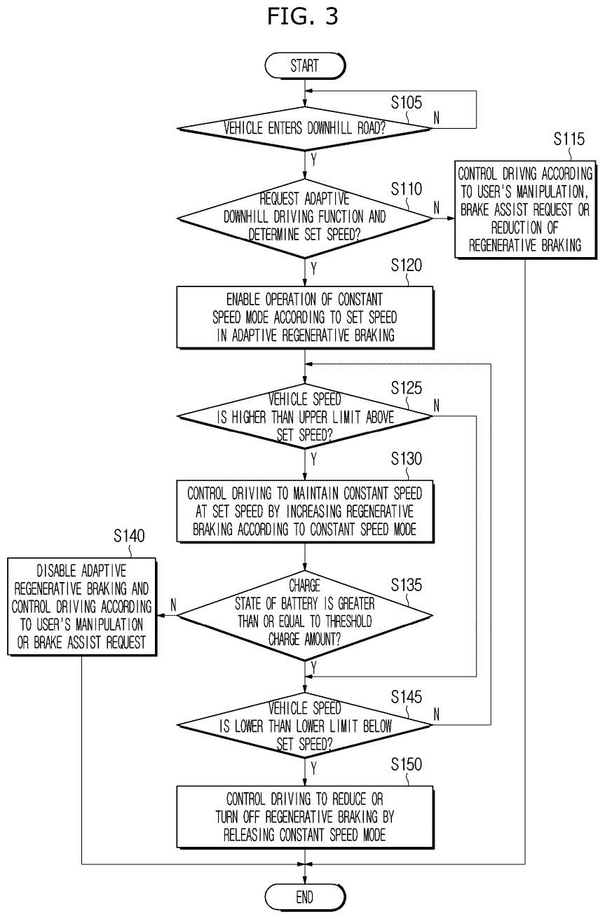

In embodiments of the present disclosure, the processor 124 may be implemented as a single processing module that executes the above-described processing associated with a function of an adaptive regenerative braking unit and processing of various vehicle operations. As another example, the processor 124 may have the above-described processing as distributed processing over a plurality of processing modules. For example, a vehicle control unit (VCU) may process perception of a vehicle speed and situation information according to a request of a function, initiation of a constant speed mode according to a set speed, release of the constant speed, and disabling of adaptive regenerative braking, and a motor control unit (MCU) may perform driving control according to required torque according to a constant speed mode. In embodiments of the present disclosure, for convenience of explanation, even if the processor 124 including a plurality of processing modules performs the above-described processes, the processor 124 illustrated in FIG. 2 is described to commonly refer to the plurality of processing modules. The above-described processing of the processor 124 will be described in detail through FIG. 3 to FIG. 11.

Referring to FIG. 3, a driving control method using adaptive regenerative braking according to another embodiment of the present disclosure will be described in detail. This embodiment is described with focus on adaptive regenerative braking in downhill driving. FIG. 3 is a flowchart of a driving control method using adaptive regenerative braking according to another embodiment of the present disclosure.

First, the processor 124 of the vehicle 100 may determine whether or not the running vehicle 100 has entered a downhill road (S105).

For example, entry into the downhill road may be determined by at least one of map information associated with a route where the vehicle 100 is running and slope information on the route. The processor 124 may identify a position corresponding to a location of the vehicle 100 in the map information, check slope information of the identified position from the map information, and determine whether or not the vehicle 100 has entered the downhill road, based on the checked slope information. The slope information may also be obtained from the gradient sensor 102e apart from the map information, and the processor 124 may estimate whether the vehicle 100 has entered the downhill road based on the slope information and a duration of downhill driving.

Next, the processor 124 may check, after the vehicle 100 enters the downhill road, whether or not there is a request of a function for adaptive downhill driving to implement maintenance of a constant speed in downhill driving of the vehicle 100 by adaptive regenerative braking and determine a set speed accompanying the request of the function (Silo).

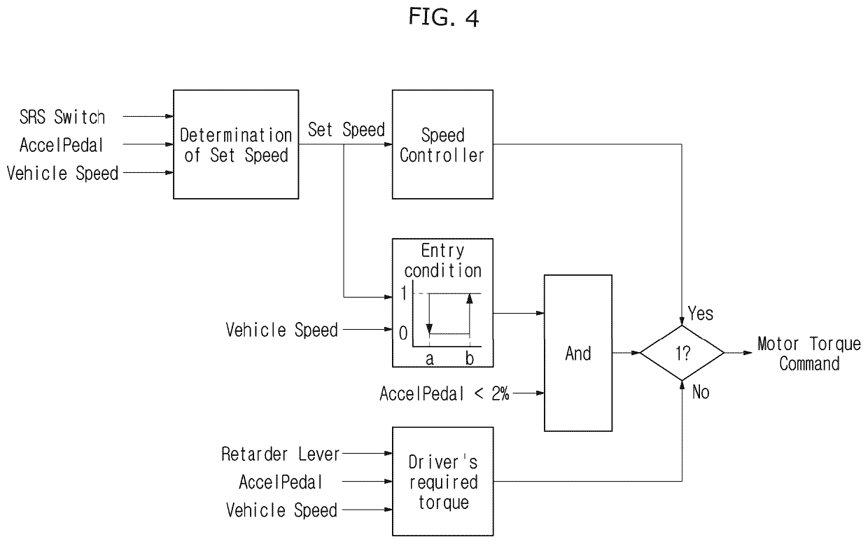

The request of the function may be received by at least one of a user's request, which turns on an adaptive downhill driving function, and a user's acceleration demand level that is below a reference demand level. For example, the adaptive downhill driving function may be turned on by a user's operation through a hardware interface such as a button or an operation lever or a software key provided on the display 106. The user's request may be referred to as the SRS Switch in FIG. 4. FIG. 4 is a view showing a control loop to which a constant speed mode of adaptive regenerative braking is applied.

For example, an acceleration demand may be identified through a depression degree of an acceleration pedal or a maneuver amount of an interface for acceleration request. In an acceleration pedal, an acceleration demand level may correspond to AccelPedal in FIG. 4. An acceleration demand level may be measured by the acceleration demand level sensor 102d that detects a depression degree or a maneuver amount. A reference demand level may be designated as 2%, for example, and may be set without being limited thereto according to various situations and design specifications.

A set speed may be determined as a vehicle speed at a time of receiving the request of the function. In FIG. 4, a vehicle speed and a set speed may correspond to Vehicle Speed and Set Speed, respectively. In case the request of the function is identified by a combination of a user's request and the user's acceleration demand level, the processor 124 may keep checking, after the user's request, whether or not the acceleration demand level is equal to or lower than the reference demand level. For example, even after a user enters a downhill road, there may be acceleration demand exceeding a reference demand level. In case an acceleration demand level, in which the user's acceleration demand is estimated to have actually been released, that is, an acceleration demand level equal to or lower than the reference demand level, is detected at a point in the middle of the downhill road, a vehicle speed corresponding to a time of the detection may be set as a final set speed. Accordingly, by adaptive regenerative braking, the vehicle 100 may run on the downhill road at the set speed without acceleration demand, and the user may not experience a drastic decrease of vehicle speed or an incongruous decrease of vehicle speed attributable to the existing regeneration, so that excellent ride comfort and good convenience may be achieved during downhill driving.

In case the request of the function is absent, the processor 124 may control downhill driving according to the user's maneuver request, a brake assist demand, or deceleration of regeneration (S115). For example, the user maneuver may be a braking request through a main braking module or an acceleration request, and the brake assist demand may be the user's demand for a brake assist device such as a retarder. The deceleration of regeneration may be lowering a vehicle speed by non-adaptive regenerative braking suitable for a specific speed regardless of a slope or by regeneration through a different mode among adaptive regeneration braking types.

When the request of the function is received, the processor 124 may enable an operation of a constant speed mode according to a set speed in adaptive regenerative braking during downhill driving (S120).

Enabling the operation for the constant speed mode may include a process of checking various conditions for initiating the constant speed mode that tunes regeneration to make a vehicle speed converge to the set speed. For example, through the enabling, the processor 124 may identify and analyze a vehicle speed measured by the speed sensor 102c and situation information as a preliminary process for the operation.

According to specifications, the vehicle 100 may also be equipped with a brake assist device available for brake assist during downhill driving, for example, a retarder. In case both the request of the function and the user's use request for the retarder are present, the processor 124 may disable brake assist by the retarder and keep enabling the operation of adaptive regenerative braking according to a setting of the user or the processor 124. In the control loop illustrated in FIG. 4, required torque of the motor unit 114 based on regeneration according to a constant speed mode is calculated in response to the absence of use request for a retarder that corresponds to Retarder Lever. Nevertheless, in order to enable adaptive regenerative braking to prefer brake assist by the retarder, when the setting is designated, the processor 124 may determine that there is no brake assist request and perform regeneration according to the constant speed mode.

Next, the processor 124 may determine whether or not a vehicle speed in downhill driving is higher than an upper limit above a set speed (S125). The upper limit corresponds to b in FIG. 4, and for example, it may be a sum of the set speed and 1 kph and be adaptively set according to a vehicle speed, downhill information, and specifications of the vehicle 100.

In case the vehicle speed is higher than the upper limit, the processor 124 may initiate a constant speed mode belonging to a type of adaptive regenerative braking and control driving of the vehicle 100 to tune the regeneration according to the constant speed mode and make the vehicle speed converge to the set speed (S130).

As shown in FIG. 4, an initiation condition (or entry condition) of the constant speed mode may be set as a hysteresis condition. In case an initiation condition defining a vehicle speed to be higher than an upper limit is satisfied, the processor 124 may determine a regeneration amount based on slope information of a downhill route, a weight of the vehicle 100, a current vehicle speed, and a set speed. Next, the processor 124 may calculate required torque of the motor unit 114 based on the determined regeneration amount. The required torque may correspond to Motor Torque Command in FIG. 4. The processor 124 may control the motor unit 114 through the required torque to realize downhill driving at the set speed. The slope information may be obtained from at least one of map information and the gradient sensor 102e, and the weight may be acquired by the weight estimation sensor 102f. The current vehicle speed may be measured by the speed sensor 102c.

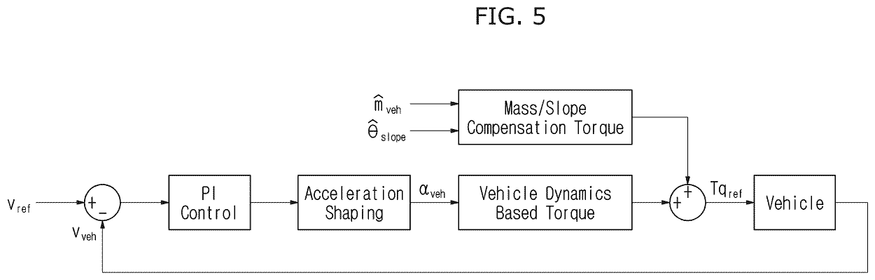

For example, required torque may be calculated by the control loop illustrated in FIG. 5. FIG. 5 is a view showing a control loop for determining required torque according to downhill slope compensation. In FIG. 5, Tq_{ref} may be required torque, \hat{m}ᵥₑₕ may be an estimated vehicle weight, uᵣₑₕ may be a set speed, and uᵥₑₕ may be a current vehicle speed in downhill driving. \hat{θ}ₛₗₒₚₑ may be a slope of a current downhill point of downhill driving, and a_{ref} may be an acceleration for maintaining a set speed and may be estimated through acceleration shaping. For example, required torque is obtained by an equation of vehicle dynamics base torque of the vehicle 100, and the equation may be a_{ref}×\hat{m}ᵥₑₕ×rₜᵢᵣₑ. Here, rₜᵢᵣₑ may be a radius of a wheel. Slope information and a weight may change on a downhill route, and a logic for compensating required torque may be prepared to calculate required torque reflecting a state of change. In FIG. 5, the logic corresponds to Mass/Slope Compensation Torque, and the control loop of FIG. 5 may be configured to include a downhill slope compensation logic. Accordingly, when slope information and a weight do not change, required torque may not vary. On the other hand, when at least one of slope information and a weight changes during downhill driving, required torque related to regeneration for the downhill driving may change. Even when a slope changes during downhill driving, a downhill slope compensation logic may be used to maintain a vehicle speed at a set speed so that required torque affected by a change of slope may be compensated. The processor 124, which uses the control loop of FIG. 5, may use compensated required torque determined by the logic and thus control downhill driving to make a vehicle speed converge to a set speed.

A downhill slope compensation logic is implemented in a state where adaptive regenerative braking is enabled in downhill driving and may not be used in non-adaptive regenerative braking and other types of adaptive regenerative braking, for example, in a required deceleration mode and a following deceleration mode. In addition, in case of a decrease in slope, if regeneration is maintained based on a slope before the decrease, a vehicle speed may be lowered by high regeneration. The lowered vehicle speed may become lower than an upper limit, and such a state may not satisfy an initiation condition of a constant speed mode so that regeneration according to the constant speed mode may be released. Thus, the vehicle 100 may have downhill driving not at a converged set speed but at a speed lower than the set speed. In order to prevent such a phenomenon, a regeneration amount and required torque may be compensated along a decrease of slope, and a driving state of the vehicle 100 may enter the initiation condition of the constant speed mode more frequently. As the driving state satisfies the initiation condition as frequently as possible, regeneration according to the constant speed mode may be efficiently performed.

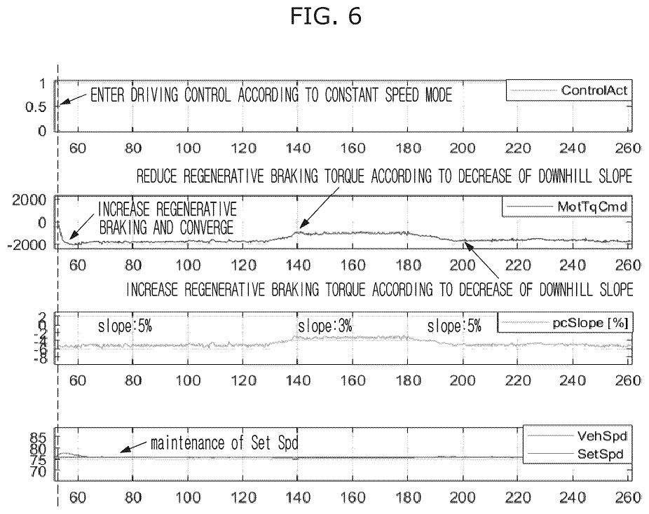

FIG. 6 is a timing chart exemplifying determination of required torque according to downhill slope compensation and constant speed maintenance converging into a set speed.

In FIG. 6, an initial slope of a downhill road is 5%, and a vehicle speed Veh Spd at an initial phase of entering the downhill road and a set speed Set Spd are about 78 kph and about 75 kph, respectively. When a driving state of the vehicle 100 enters a constant speed mode (ControlAct=1), required torque corresponding to a regeneration amount according to the constant speed mode may be calculated through a downhill slope compensation logic based on the initial slope of 5%. The regeneration amount of the constant speed mode increases and converges in an initial section of the downhill road, and the required torque thus calculated may also be generated in accordance with the regeneration amount. Accordingly, the vehicle speed may converge to the set speed, and the vehicle 100 may maintain a constant speed during downhill driving.

When the vehicle 100 is running in a middle region of the downhill road with a slope of 3%, the processor 124 may calculate a regeneration amount and required torque compensated by the reduced slope through the logic. The compensated required torque may be calculated to be smaller than required torque of the slope of 5%, and as the processor 124 controls downhill driving by the compensated required torque, the vehicle 100 may be driven at a constant speed while maintaining the vehicle speed at the set speed of 75 kph corresponding to the slope of 5%.

Next, while controlling the downhill driving of the vehicle 100 by applying the constant speed mode, the processor 124 may check whether a charge state of the battery 110 is equal to or greater than a threshold charge amount (S135).

The threshold charge amount may be a fixed value or a value that varies dynamically. In case the threshold charge amount varies dynamically, the threshold charge amount may be estimated based on, for example, an average slope of a downhill road, a distance from a current location to a downhill end point, a specification of the battery 110, and an expected regeneration amount according to maintenance of a constant speed mode. When regeneration according to the constant speed mode fully charges the battery 110, adaptive regenerative braking may be unexpectedly released. Thus, the vehicle speed may increase drastically thereby degrading ride comfort and driving safety. Considering this, the processor 124 may monitor a charge state according to regeneration of the constant speed mode.

In case a charge state of the battery 110 in adaptive downhill driving is equal to or greater than the threshold charge amount, the processor 124 may disable adaptive regenerative braking so that the constant speed mode is not applied (S140). Then, the processor 124 may control driving by at least any one of a user's manipulation or the user's brake assist request. For example, the user's manipulation may be a main brake request or an acceleration request, and the brake assist request may be a use request for the retarder.

In embodiments of the present disclosure, steps S135 and S140 are described to be performed after step S130 but may be performed after step S120.

Next, in a case the charge state of the battery 110 is not equal to or greater than the threshold charge amount, the processor 124 may determine whether or not the vehicle speed in downhill driving is lower than a lower limit below the set speed (S145). The lower limit corresponds to a in FIG. 4, and for example, it may be a value obtained by subtracting 1 kph from the set speed and may be adaptively set according to a vehicle speed, downhill information, and specifications of the vehicle 100. As shown in the hysteresis condition of FIG. 4, the constant speed mode applied to the downhill driving may be released.

When the constant speed mode is released because the vehicle speed is below the lower limit, the processor 124 may control the driving of the vehicle 100 to reduce or turn off the regeneration (S150). When the vehicle speed is higher than the lower limit, the processor 124 may perform steps S125 to S145.

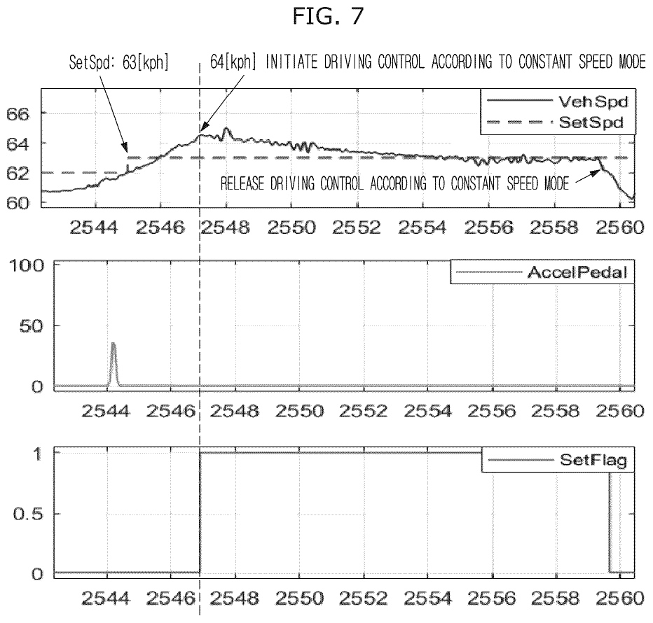

FIG. 7 is a view exemplifying a vehicle speed change on a downhill route according to initiation and release of a constant speed mode.

A user may request a function of adaptive downhill driving that uses active regeneration. The function may be enabled in response to the user's request and the user's acceleration demand level that is below a reference demand level. As illustrated in FIG. 7, a set speed SetSpd is determined as 63 kph corresponding to a time when the user's acceleration demand level AccelPedal becomes lower than the reference demand level. When the vehicle 100 runs on a downhill road at a vehicle speed of 64 kph that is higher than an upper limit, the processor 124 may determine that a driving state of the vehicle 100 enters a constant speed mode using regeneration and thus changes SetFlag from 0 to 1. FIG. 7 shows that, as the vehicle speed increases on the downhill road, a regeneration amount increases to converge to the set speed of 63 kph and required torque of the motor unit 114 is tuned to meet the increasing regeneration amount. That is, as the regeneration is performed according to the constant speed mode, the vehicle speed may be maintained at the set speed of 63 kph. The vehicle 100, which keeps a constant speed close to the set speed, may run while decelerating. When the decelerating vehicle 100 runs at a vehicle speed below a lower limit of 62 kph, the processor 124 determines to release an entry mode and changes SetFlag from 0 to 1. By the processor 124, the vehicle 100, in which the application of the entry mode is released, may monitor whether or not to re-enter the constant speed mode of adaptive regenerative braking.

According to embodiments of the present disclosure, by active regeneration control of the vehicle 100, a vehicle speed at a time when a user's acceleration request does not actually exist may be determined as a set speed of downhill driving, and the vehicle speed of the vehicle 100 may converge to the set speed by tuning regeneration according to the constant speed mode. That is, because the vehicle speed may be constantly maintained as a speed at a time when an acceleration demand ceases to exist, no drastic change of vehicle speed occurs, and the sense of incompatibility in driving may be suppressed. Thus, ride comfort and use convenience may be improved. In addition, because regeneration is determined in consideration of ride comfort and battery state, optimal charge efficiency may be ensured.

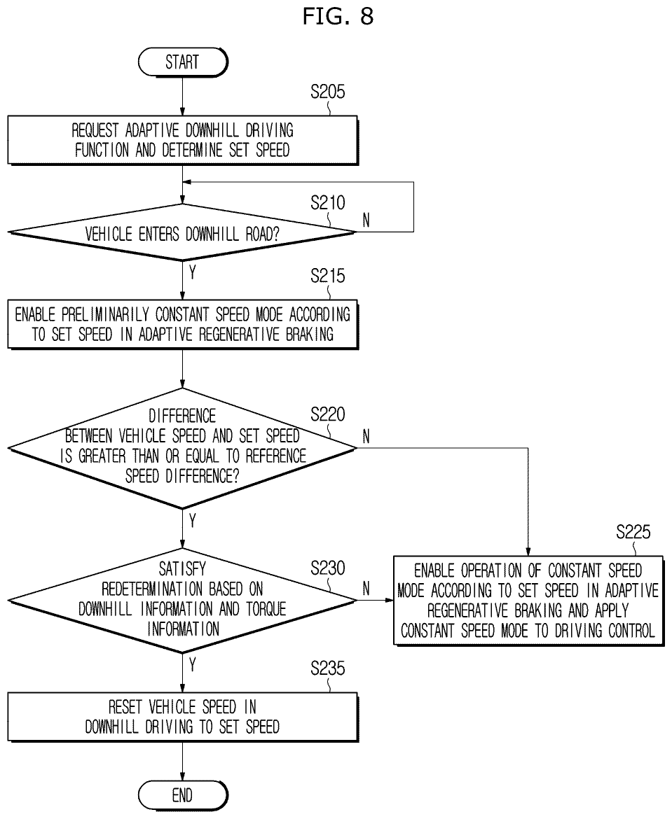

FIG. 8 is a flowchart for a process of redetermining a set speed according to yet another embodiment of the present disclosure. Unlike FIG. 3, this embodiment shows that the vehicle 100 receives a request of a function for adaptive downhill driving and a set speed accompanying the request before the vehicle enters a downhill road.

First, while the vehicle 100 is running not on a downhill route but on a flat route or an uphill route, the processor 124 may receive a request of a function for adaptive downhill driving and determine a set speed accompanying the request for the function (S205).

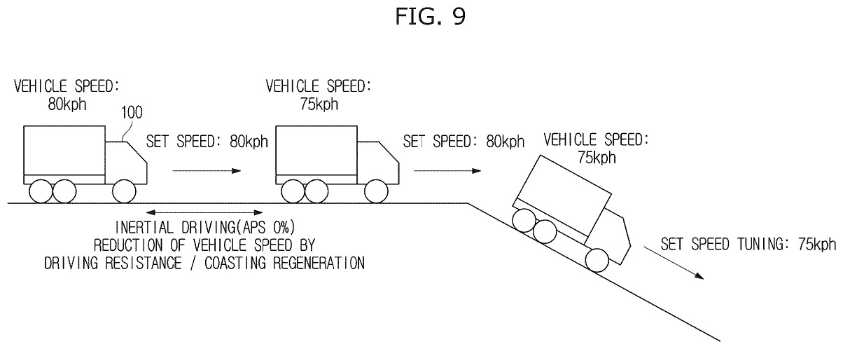

Like FIG. 3, the request of the function may be received by at least one of a user's request, which turns on an adaptive downhill driving function, and a user's acceleration demand level that is below a reference demand level. A set speed may be determined as a vehicle speed at a time of receiving the request of the function. As exemplified in FIG. 9, when the vehicle 100 receives a user request associated with the function and the vehicle 100 moves only by inertial driving because there is no acceleration demand by an acceleration pedal, the processor 124 may determine a set speed as a vehicle speed of 80 kph corresponding to a time when there is no acceleration demand. FIG. 9 is a view schematically exemplifying a process of redetermining a set speed. A vehicle speed of the vehicle 100 may be lowered to 75 kph due to inertial driving before entering a downhill route. For example, deceleration may be attributable to driving resistance, coasting regeneration, and the like.

Next, the processor 124 may determine whether or not the running vehicle 100 has entered the downhill road (S210).

For example, entry into the downhill road may be determined by at least one of map information associated with a route where the vehicle 100 is running, slope information on the route, and vehicle speed information on the route. An operation of determining the entry into the downhill road based on map information and slope information is actually the same as that of FIG. 3. In case the entry into the downhill road is determined based on speed information, if the vehicle speed is higher than the set speed while a user's acceleration demand, for example, a depressing operation of an acceleration pedal is not detected, the processor 124 may estimate the entry into the downhill road by the vehicle 100.

Next, when the entry into the downhill road is detected, the processor 124 may preliminarily enable an operation of a constant speed mode in adaptive regenerative braking during downhill driving (S215).

Similar to FIG. 3, the preliminary enabling of the operation for the constant speed mode may include a process of checking various states for initiating the constant speed mode. For example, through the preliminary enabling, the processor 124 may identify and analyze a vehicle speed measured by the speed sensor 102c and situation information as a preliminary process for the operation.

Preliminary enabling according to this embodiment may include an analysis process regarding whether or not a difference between an initial vehicle speed at entry into a downhill road and a set speed is equal to or greater than a reference speed difference. As exemplified in FIG. 9, the vehicle 100 may have a vehicle speed of 75 kph through inertial driving before entering a downhill road, and when the vehicle 100 enters the downhill road, the vehicle 100 may run at the vehicle speed of 75 kph according to the inertial driving. Because the vehicle speed of 75 kph is a lot different from a set speed of 85 kph, if the set speed at the time of requesting the function is applied to a constant speed mode, the vehicle speed may drastically change at an initial point of the downhill road.

Next, based on an analysis result, the processor 124 may determine whether or not the difference between the vehicle speed in downhill driving and the set speed is equal to or greater than the reference speed difference (S220).

For example, the reference speed difference may be a fixed value according to a specification of the vehicle 100 or a value that varies dynamically. As an example, the fixed value may be 3 kph, and a dynamically variable reference speed difference may be adaptively set according to a specification of the vehicle 100, a vehicle speed, downhill information, and the like.

In case the difference between the vehicle speed and the set speed is less than the reference speed difference, the processor 124 may perform steps S120 to S150 of FIG. 3 to enable an operation of the constant speed mode according to the set speed in adaptive regenerative braking and apply the constant speed mode to driving control (S225).

On the other hand, in case the difference between the vehicle speed in downhill driving and the set speed is equal to or greater than the reference speed difference, the processor 124 may determine whether or not a redetermination condition of the set speed is satisfied (S230).

For example, information used to determine the redetermination condition may be a condition based on slope information associated with a downhill route, where the vehicle 100 is running, and torque information of the vehicle 100 on the downhill route. The slope information may be obtained from road information of map information and include an average slope of the downhill route and a slope distance of the downhill route. The torque information may include resistance torque caused by resistance according to the downhill route and required torque that is determined by the constant speed mode. The required torque may be generated based on a set speed, which is initially determined according to the request of the function, and a current vehicle speed and may specifically be calculated using a logic according to the speeds and downhill slope compensation described in FIG. 3.

The resistance torque may be generated by the processor 124 and may be calculated based on a wheel radius of the vehicle 100, an estimated weight of the vehicle 100 measured from the weight estimation sensor 102f, and an average slope of a downhill road where the vehicle 100 is running. The resistance torque of the torque information may include slope torque by a resistant friction according to a sloping surface of a downhill road, drag torque by a vertical friction of the downhill road, and roll torque according to roll resistance of the vehicle 100 against the downhill road. The slope torque Tₛₗₒₚₑ may be obtained by r×\hat{m}g×sin θ. Here, r may be a dynamic radius of wheel, m may be an estimated weight of the vehicle 100, and θ may be an average slope of downhill road. The drag torque T_{drag} may be obtained by r×\hat{m}g×Cᵣ×cos θ. The roll torque Tᵣₒₗₗ may be obtained by r×0.5×ρ×C_{d}×A×V². Here, V and A may be a vehicle speed and an effective overall area of the vehicle 100. ρ may be an atmospheric density, and C_{d} may be an aerodynamic coefficient of the vehicle and may be determined based on an experiment.

The processor 124 may check whether or not an average slope of a downhill route, where the vehicle 100 is running, is equal to or greater than a threshold slope and may determine that a primary redetermination condition is satisfied if the average slope is equal to or greater than the threshold slope. If a slope distance is equal to or greater than a threshold distance, the processor 124 may determine that a secondary redetermination condition is satisfied. If a sum of resistance torque and required torque is greater than a predetermined value, for example, 0, the processor 124 may determine that a third redetermination condition is satisfied. The above-described redetermination conditions may be conditions under which the vehicle 100 may accelerate from a vehicle speed after entering a downhill road to an initially determined set speed.

The processor 124 may determine, as an example, whether or not all the above-described redetermination conditions are satisfied or may check, as another example, only some of the above-described redetermination conditions and determine whether or not a redetermination condition is satisfied.

Next, in case a redetermination condition is satisfied, the processor 124 may reset a vehicle speed in downhill driving as a set speed (S235).

As exemplified in FIG. 9, the vehicle speed in downhill driving may be the vehicle speed of 75 kph at an initial entry point of a downhill road, and the vehicle speed of 75 kph may be reset as a set speed. Accordingly, the set speed may change from the initial set speed of 80 kph to the vehicle speed of 75 kph in downhill driving. Then, the processor 124 may perform steps S120 to S150 based on the tuned set speed. That is, the processor 124 may enable an operation of the constant speed mode according to the reset set speed and apply the constant speed mode to driving control.

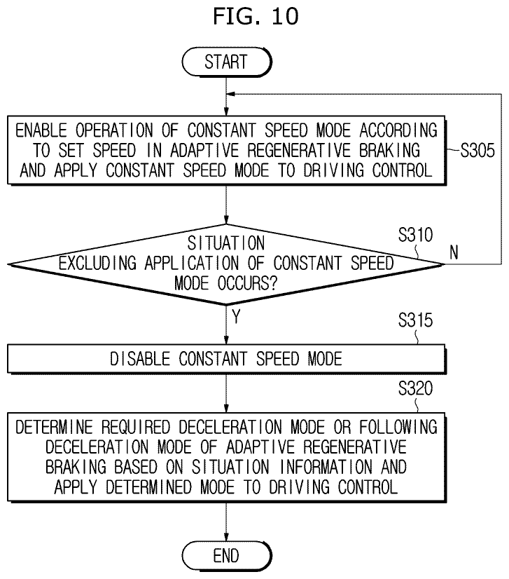

FIG. 10 is a flowchart for a process of determining a mode of adaptive regenerative braking based on an exceptional situation according to yet another embodiment of the present disclosure. This embodiment shows that, after the operation of adaptive regenerative braking according to step S120 of FIG. 3 is enabled, if a predetermined situation occurs to a downhill route, a constant speed mode is disabled and driving is controlled in another mode of adaptive regenerative braking.

First, the processor 124 may perform the process according to step S120 of FIG. 3. Specifically, the processor 124 may enable an operation of a constant speed mode according to a set speed in adaptive regenerative braking and apply the constant speed mode to driving control (S305).

The application of the constant speed mode may include a process of checking whether or not a driving state of the vehicle 100 according to a vehicle speed enters an initiation condition of the constant speed mode and a process of controlling the vehicle 100 entering the initiation condition by adaptive regenerative braking of the constant speed mode. In embodiments of the present disclosure, the application of the constant speed mode may be referred to as including both a state where driving control according to the constant speed mode is not applied yet and a state where application of the driving control is performed.

Next, the processor 124 may detect whether or not a situation occurs where the application of the constant mode is excluded, either before the application of the driving control according to the constant speed mode or while the application is performed (S310).

Based on situation information associated with a driving situation, the processor 124 may detect occurrence of an exceptional situation that excludes the application of the constant speed mode. For example, the situation information may be obtained from the sensor unit 102, map information, and the another device 200. The another device 200 may be the server 200, the another vehicle 300, and the like. Situation information associated with this embodiment may include dynamic object information on a front route of the vehicle 100, driving caution information requiring a specific form of driving on a front route, and traffic information on a front route. For example, dynamic object information may be obtained from a radar sensor of the observation sensor 102b and data received from the another device 200. Static object information may be acquired from road information of map information. Traffic information may be acquired from the server 200.

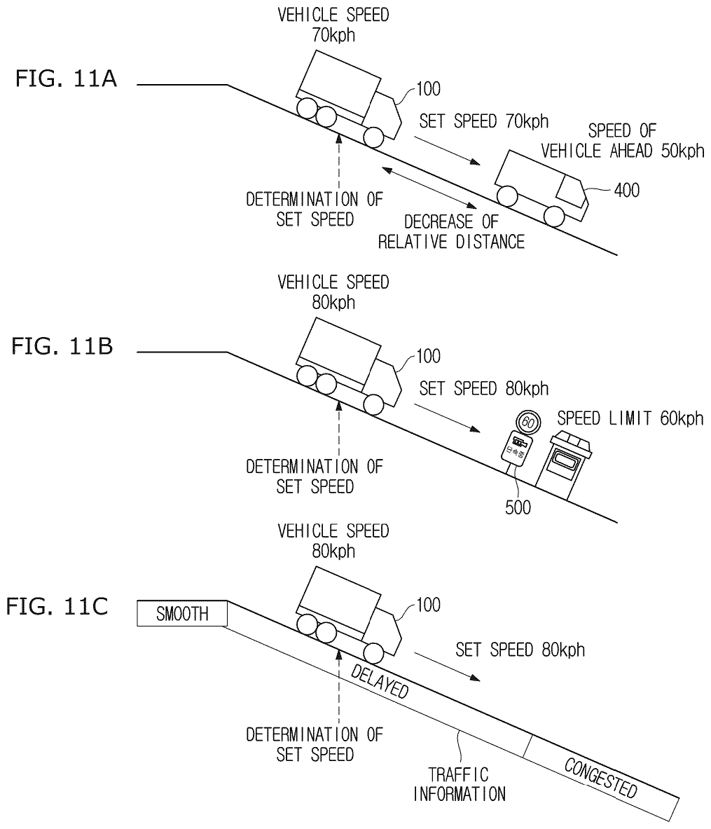

Referring to FIG. 11, which includes FIGS. 11A-11C, a situation excluding the application of a constant speed mode and situation information will be described through examples. FIG. 11 is a view schematically exemplifying exceptional situations.

FIG. 11A shows that a radar sensor recognizes a dynamic object ahead on a downhill route, for example, a preceding vehicle 400, while the vehicle 100 to which a constant speed mode is applied is running on the route. As for situation information, the processor 124 of the vehicle 100 may obtain dynamic object information associated with the preceding vehicle 400 through a lidar sensor. The situation information of the preceding vehicle 400 may include detected mobility of the preceding vehicle 400, a relative distance from the preceding vehicle 400, a speed of the preceding vehicle 400, and a movement direction of the preceding vehicle 400.

By using the situation information, the processor 124 may compare a set speed of the vehicle 100 (70 kph in FIG. 11A) and the speed of the preceding vehicle 400 (50 kph in FIG. 11A) and determine whether or not the set speed of the vehicle 100, to which the constant speed mode is applied, is higher than the speed of the preceding vehicle 400. In case the set speed of the vehicle 100 is higher, the processor 124 may estimate that a relative distance between the vehicle 100 and the preceding vehicle 400 decreases. As another example, in case the processor 124 identifies a decrease of the relative distance by using the situation information, it may determine that the vehicle speed of the vehicle 100, to which the constant speed mode is applied, is higher than the speed of the preceding vehicle 400. The processor 124 may analyze whether or not a regeneration amount (or required torque for ensuring safety) of the vehicle 100 for securing a safety distance from the preceding vehicle 400 is larger than a regeneration amount (or required torque) of the vehicle 100 to which the constant speed mode is applied.

When detecting at least one of the decrease of the relative distance and the regeneration amount for securing the safety distance is larger than that of the constant speed mode, the processor 124 may determine that an exceptional situation associated with excluding the application of the constant speed mode occurs because of the preceding vehicle 400.

FIG. 11B shows that the vehicle 100 perceives a static object ahead on a downhill route, for example, a speed enforcement device 500, while the vehicle 100 to which a constant speed mode is applied is running on the route. As for situation information, the processor 124 of the vehicle 100 may obtain driving caution information associated with the speed enforcement device 500 obtained from map information. The situation information of the speed enforcement device 500 may include a required specific driving type (for example, speed limit) and a distance from a current location to the speed enforcement device 500.

By using the situation information, the processor 124 may compare a set speed of the vehicle 100 (80 kph in FIG. 11B) and the speed limit of the speed enforcement device 500 (60 kph in FIG. 11B) and determine whether or not the set speed of the vehicle 100, to which the constant speed mode is applied, is higher than the speed limit. In addition, the processor 124 may analyze whether or not a regeneration amount (or required torque for observing the speed limit) of the vehicle 100 for observing the speed limit is larger than a regeneration amount (or required torque) of the vehicle 100 to which the constant speed mode is applied.

When detecting at least one of the set speed is higher than the speed limit and the regeneration amount for the speed limit is larger than that of the constant speed mode, the processor 124 may determine that an exceptional situation associated with excluding the application of the constant speed mode occurs because of the speed enforcement device 500.

FIG. 11C shows that the vehicle 100 recognizes a delayed or congested traffic flow state from traffic information on a route ahead, while the vehicle 100 to which a constant speed mode is applied is running on a downhill route. As for situation information, the processor 124 may obtain the traffic flow state obtained from the traffic information. For example, the situation information according to the traffic flow state may include an average speed of a congested or delayed section and a distance from a current location to the section.

By using the situation information, the processor 124 may compare a set speed of the vehicle 100 (80 kph in FIG. 11C) and the average speed of the delayed/congested section and determine whether or not the set speed of the vehicle 100, to which the constant speed mode is applied, is higher than the average speed. In addition, the processor 124 may analyze whether or not a regeneration amount (or following required torque) of the vehicle 100 for following the average speed is larger than a regeneration amount (or required torque) of the vehicle 100 to which the constant speed mode is applied.

When detecting at least one of the set speed is higher than the average speed and the regeneration amount for the average speed is larger than that of the constant speed mode, the processor 124 may determine that an exceptional situation associated with excluding the application of the constant speed mode occurs because of the delayed/congested section.

Next, when perceiving occurrence of an exceptional situation, the processor 124 may disable driving control according to the constant speed mode (S315).

Next, the processor 124 may control driving of the vehicle in another mode of adaptive regenerative braking based on situation information of the perceived situation (S320).

Specifically, based on the situation information, the processor 124 may determine one mode of a plurality of modes associated with a type of adaptive regenerative braking. The plurality of modes may include a required deceleration mode and a following deceleration mode. The required deceleration mode may be a type that is based on a speed of a dynamic object on a route in front of the vehicle 100, which has a decreasing relative distance from the vehicle 100, or a speed required by a static object located ahead on the route. The following deceleration mode may be a type based on a speed that is estimated from traffic information on a route ahead. The processor 124 may control driving of the vehicle by regeneration in the determined mode.

As exemplary description for each of the exceptional situations of FIG. 11, the processor 124 may determine a required deceleration based on the vehicle speed of 50 kph of the preceding vehicle 400 and enable the required deceleration mode among the plurality of types of adaptive regenerative braking. Based on the required deceleration mode, the processor 124 may determine a regeneration amount based on the vehicle speed of the preceding vehicle 400, thereby controlling the driving of the vehicle 100.

The processor 124 may determine a required deceleration based on the speed limit of 60 kph of the speed enforcement device 500 and enable the required deceleration mode among the plurality of types of adaptive regenerative braking. Based on the required deceleration mode, the processor 124 may determine a regeneration amount based on the speed limit of the speed enforcement device 500, thereby controlling the driving of the vehicle 100.

Based on an actual speed of a delayed/congested section, the processor 124 may determine a following deceleration and enable the following deceleration mode among the plurality of types of adaptive regenerative braking. Based on the following deceleration mode, the processor 124 may determine a regeneration amount based on the actual speed of the section, thereby controlling the driving of the vehicle 100.

According to embodiments of the present disclosure, active regeneration control may not only improve use convenience during downhill driving but also ensure driving safety by shifting a constant speed mode to another mode of adaptive regenerative braking according to a driving situation.

Effects obtained in embodiments of the present disclosure are not limited to the above-mentioned effects, and other effects not mentioned above may be clearly understood by those skilled in the art from the foregoing description.

While the exemplary methods of the present disclosure described above are represented as a series of operations for clarity of description, it is not intended to limit the order in which the steps are performed, and the steps may be performed simultaneously or in a different order as necessary. In order to implement the method according to embodiments of the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing embodiments of the present invention by hardware, embodiments of the present disclosure can be implemented with application specific integrated circuits (ASICs), digital signal processors (DSPs), digital signal processing devices (DSPDs), programmable logic devices (PLDs), field programmable gate arrays (FPGAs), general processors, controllers, microcontrollers, microprocessors, etc.

The scope of embodiments of the disclosure includes software or machine-executable commands (e.g., an operating system, an application, firmware, a program, etc.) for enabling operations according to the methods of various embodiments to be executed on an apparatus or a computer, and a non-transitory computer-readable medium having such software or commands stored thereon and executable on the apparatus or the computer.

What is claimed is:

1. A driving control method of a vehicle using adaptive regenerative braking, the method comprising:
before or after entry of the vehicle into a downhill road, receiving a request of a function for adaptive downhill driving for implementing maintenance of a constant speed during downhill driving of the vehicle by the adaptive regenerative braking and a set speed accompanying the request of the function;
in response to a vehicle speed during the downhill driving being equal to or higher than an upper limit above the set speed, controlling driving of the vehicle by tuning regenerative braking according to a constant speed mode belonging to a type of the adaptive generative braking to make the vehicle speed converge to the set speed; and
in response to the vehicle speed during the downhill driving being equal to or lower than a lower limit below the set speed, controlling the driving of the vehicle by reducing the regenerative braking through release of the constant speed mode.

2. The method of claim 1, wherein:
the request of the function is received by a request from a user that turns on an adaptive downhill driving function, an acceleration demand level of the user that is below a reference demand level, or both the request from the user and the acceleration demand level of the user that is below the reference demand level; and
the set speed is determined as the vehicle speed at a time at which the request of the function is received.

3. The method of claim 1, wherein:
the entry of the vehicle into the downhill road is determined by map information associated with a route on which the vehicle is running, slope information on the route, and speed information of the vehicle on the route; and
the entry based on the speed information determines that the vehicle is running on the downhill road in a case in which an acceleration request of a user is not received and the vehicle speed is higher than the set speed.

4. The method of claim 1, wherein controlling the driving of the vehicle to make the vehicle speed converge to the set speed further comprises:
in response to a charge state for a battery of the vehicle being equal to or greater than a threshold charge amount during the downhill driving, disabling the adaptive regenerative braking so as not to apply the constant speed mode; and
controlling the driving of the vehicle by a manipulation of a user or a brake assist request of the user, wherein the brake assist request is identified as a use request of the user for a retarder.

5. The method of claim 1, wherein the vehicle is equipped with a retarder that is available for brake assist during the downhill driving, and wherein the driving control method further comprises disabling the brake assist by the retarder and enabling an operation of the adaptive regenerative braking during the downhill driving in a case in which the request of a user for the function and a use request of the user for the retarder are present.

6. The method of claim 1, wherein controlling the driving of the vehicle to make the vehicle speed converge to the set speed comprises:
compensating a required torque for driving control based on a change of slope of the downhill road on which the vehicle is running; and
controlling the driving by using the compensated required torque.

7. The method of claim 1, further comprising:
in response to receiving the request of the function and the set speed before the entry of the vehicle into the downhill road, determining whether or not a redetermination condition of the set speed is satisfied based on a difference between the vehicle speed and the set speed during the downhill driving being equal to or greater than a reference speed difference; and
in response to the redetermination condition being satisfied, resetting the vehicle speed to the set speed.

8. The method of claim 7, wherein:
determining whether or not the redetermination condition is satisfied is based on downhill information associated with a downhill route for driving and torque information of the vehicle on the downhill route;
the downhill information comprises an average slope of the downhill route and a downhill distance of the downhill route;
the torque information comprises resistance torque caused by resistance according to the downhill route and required torque that is determined by the constant speed mode; and
the redetermination condition is determined to be satisfied in a case in which the average slope is equal to or greater than a threshold slope, a slope distance is equal to or greater than a threshold distance, and a sum of the resistance torque and the required torque is greater than a predetermined value.

9. The method of claim 1, further comprising:
after receiving the request of the function and the set speed, enabling an operation of the adaptive regenerative braking during the downhill driving;
before application of driving control according to the constant speed mode or during execution of the application, detecting whether or not a situation excluding application of the constant speed mode occurs;
in response to the situation being detected, disabling the driving control according to the constant speed mode; and
controlling the driving of the vehicle in another mode of the adaptive regenerative braking based on situation information of the detected situation.

10. The method of claim 9, wherein controlling the driving of the vehicle in the another mode comprises:
determining, based on the situation information, one mode of a plurality of modes associated with a type of the adaptive regenerative braking, wherein the plurality of modes comprises a required deceleration mode and a following deceleration mode, wherein the required deceleration mode is a type based on a speed of a dynamic object that is on a route ahead of the vehicle and has a decreasing relative distance from the vehicle or is a type based on a speed required by a static object located on the route ahead of the vehicle, and wherein the following deceleration mode is a type based on a speed that is estimated from traffic information on the route ahead of the vehicle; and
controlling the driving of the vehicle by a regenerative braking method in the determined mode.

11. A vehicle implementing driving control using adaptive regenerative braking, the vehicle comprising:
a vehicle body and a wheel coupled to the vehicle body;
a battery configured to supply power to the vehicle;
one or more processors; and
a non-transitory storage device storing a program for controlling the vehicle to be executed by the one or more processors, the program including instructions to:
before or after entry of the vehicle into a downhill road, receive a request of a function for adaptive downhill driving for implementing maintenance of a constant speed during downhill driving of the vehicle by the adaptive regenerative braking and a set speed accompanying the request of the function;
in response to a vehicle speed during the downhill driving being equal to or higher than an upper limit above the set speed, control driving of the vehicle by tuning regenerative braking according to a constant speed mode belonging to a type of the adaptive generative braking to make the vehicle speed converge to the set speed; and
in response to the vehicle speed during the downhill driving being equal to or lower than a lower limit below the set speed, control the driving of the vehicle by reducing the regenerative braking through release of the constant speed mode.

12. The vehicle of claim 11, wherein:
the request of the function is received by a request of a user that turns on an adaptive downhill driving function, an acceleration demand level of the user that is below a reference demand level or both the request from the user and the acceleration demand level of the user that is below the reference demand level; and
the set speed is determined as the vehicle speed at a time at which the request of the function is received.

13. The vehicle of claim 11, wherein:
the entry of the vehicle into the downhill road is determined by map information associated with a route on which the vehicle is running, slope information on the route, and speed information of the vehicle on the route; and
the entry based on the speed information determines that the vehicle is running on the downhill road in a case in which an acceleration request of a user is not received and the vehicle speed is higher than the set speed.

14. The vehicle of claim 11, wherein the program further includes instructions to:
while controlling the driving of the vehicle to make the vehicle speed converge to the set speed, disable the adaptive regenerative braking not to apply the constant speed mode in response to a charge state for the battery of the vehicle being equal to or greater than a threshold charge amount during the downhill driving; and
control the driving of the vehicle by a manipulation of a user or a brake assist request of the user, wherein the brake assist request is identified as a use request of the user for a retarder.

15. The vehicle of claim 11, further comprising a retarder available for brake assist during the downhill driving, wherein the program further includes instructions to disable the brake assist by the retarder and enable an operation of the adaptive regenerative braking during the downhill driving in a case in which the request of a user for the function and a use request of the user for the retarder are present.

16. The vehicle of claim 11, wherein the instructions to control the driving of the vehicle to make the vehicle speed converge to the set speed comprise instructions to:
compensate a required torque for driving control based on a change of slope of the downhill road on which the vehicle is running; and
control the driving by using the compensated required torque.

17. The vehicle of claim 11, wherein the program further includes instructions to:
in response to receiving the request of the function and the set speed before the entry of the vehicle into the downhill road, determine whether or not a redetermination condition of the set speed is satisfied based on a difference between the vehicle speed and the set speed during the downhill driving being equal to or greater than a reference speed difference; and
in response to the redetermination condition being satisfied, reset the vehicle speed to the set speed.

18. The vehicle of claim 17, wherein:
the instructions to determine whether or not the redetermination condition is satisfied comprise instructions to determine whether or not the redetermination condition is satisfied based on downhill information associated with a downhill route for driving and torque information of the vehicle on the downhill route;
the downhill information comprises an average slope of the downhill route and a downhill distance of the downhill route;
the torque information comprises resistance torque caused by resistance according to the downhill route and required torque that is determined by the constant speed mode; and
the redetermination condition is determined to be satisfied in a case in which the average slope is equal to or greater than a threshold slope, a slope distance is equal to or greater than a threshold distance, and a sum of the resistance torque and the required torque is greater than a predetermined value.

19. The vehicle of claim 11, wherein the program further includes instructions to:
after receiving the request of the function and the set speed, enable an operation of the adaptive regenerative braking during the downhill driving;
before application of driving control according to the constant speed mode or during execution of the application, detect whether or not a situation excluding application of the constant speed mode occurs;
in response to the situation being detected, disable the driving control according to the constant speed mode; and
control the driving of the vehicle in another mode of the adaptive regenerative braking based on situation information of the detected situation.

20. The vehicle of claim 19, wherein the instructions to control the driving of the vehicle in the another mode comprise instructions to:
determine, based on the situation information, one mode of a plurality of modes associated with a type of the adaptive regenerative braking, wherein the plurality of modes comprises a required deceleration mode and a following deceleration mode, wherein the required deceleration mode is a type based on a speed of a dynamic object that is on a route ahead of the vehicle and has a decreasing relative distance from the vehicle or is a type based on a speed required by a static object located on the route ahead of the vehicle, and wherein the following deceleration mode is a type based on a speed that is estimated from traffic information on the route ahead of the vehicle; and
control the driving of the vehicle by a regenerative braking method in the determined mode.
